(19) United States
(12) Patent Application Publication
(10) Pub. No.: US 2025/0111482 A1
(43) Pub. Date: Apr. 3, 2025

(54) TRAINING DATA, IMAGE PROCESSING DEVICE, IMAGING APPARATUS, LEARNING DEVICE, METHOD OF CREATING TRAINING DATA, METHOD OF GENERATING TRAINED MODEL, IMAGE PROCESSING METHOD, INFERENCE METHOD, AND PROGRAM

(71) Applicant: FUJIFILM Corporation, Tokyo (JP)

(72) Inventor: Shinya FUJIWARA, Saitama (JP)

(73) Assignee: FUJIFILM Corporation, Tokyo (JP)

(21) Appl. No.: 18/895,293

(22) Filed: Sep. 24, 2024

(30) Foreign Application Priority Data
Sep. 28, 2023 (JP) 2023-168750

(51) Int. Cl. G06T 5/60; G06T 5/94; G06T 7/90; G06T 11/00

(52) U.S. Cl. CPC G06T 5/60; G06T 5/94; G06T 7/90; G06T 11/001; G06T 2207/20081; G06T 2207/20084; G06T 2207/20208

(57) ABSTRACT

Training data includes an example image determined by assuming a captured image obtained by imaging a subject, and a correct answer image. The example image is an image represented by a plurality of first signal values indicating three primary colors of light. The correct answer image is an image represented by a plurality of second signal values indicating the three primary colors. The plurality of first signal values are saturated in order in accordance with an increase in brightness of the subject, and at least two of the plurality of second signal values are increased in accordance with an increase in the brightness of the subject without being saturated in a low brightness region and a medium brightness region among the low brightness region of the subject, the medium brightness region of the subject, and a high brightness region of the subject.

### CROSS-REFERENCE TO RELATED APPLICATIONS

This application claims priority under 35 USC 119 from Japanese Patent Application No. 2023-168750 filed on Sep. 28, 2023, the disclosure of which is incorporated by reference herein.

### BACKGROUND

### 1. Technical Field

The present disclosure relates to training data, an image processing device, an imaging apparatus, a learning device, a method of creating training data, a method of generating a trained model, an image processing method, an inference method, and a program.

### 2. Related Art

JP2023-000274A discloses an aspect of inputting a captured image into a machine learning model, generating a first image by correcting a blur component of the captured image, generating a second image based on the captured image, the first image, and a weight map, in which the weight map is generated based on information related to brightness of the captured image or information related to a scene of the captured image and on information based on a saturation region in the captured image.

JP2020-166628A discloses an image processing method including a step of acquiring a training image, an out-of-dynamic range map of the training image based on a signal value of the training image and on a threshold value of the signal value, and correct answer data, and a step of performing learning of a neural network for executing a recognition or regression task using the correct answer data and input data including the training image and the out-of-dynamic range map.

WO2020/070834A discloses a method of manufacturing a trained model by performing machine learning of taking a radiation image in which a subject is captured as input and outputting a brightness adjustment parameter of the radiation image. The method of manufacturing a trained model according to WO2020/070834A comprises a step of outputting a brightness adjustment parameter of an input image included in training data via a learning model using the input image as input, a step of acquiring a value of a loss function related to the brightness adjustment parameter using the brightness adjustment parameter provided by the learning model, and a step of optimizing the learning model to decrease the value of the loss function. The loss function is configured to bias learning in a direction in which contrast is decreased, by outputting a relatively large value in a case where contrast in a predetermined region of a brightness-adjusted image after adjusting brightness is increased with respect to the training data, compared to that in a case where the contrast in the predetermined region of the brightness-adjusted image after adjusting the brightness based on the brightness adjustment parameter is decreased with respect to the training data. The loss function is also configured to output a relatively large value in a case where washing out or darkening occurs because of saturation of a pixel value in the predetermined region of the brightness-adjusted image, compared to that in a case where saturation of the pixel value is does not occur in the predetermined region.

### SUMMARY

An embodiment of the present disclosure provides training data, an image processing device, an imaging apparatus, a learning device, a method of creating training data, a method of generating a trained model, an image processing method, an inference method, and a program that can cause a trained model to generate an image having higher color reproducibility of a captured subject than an input captured image.

According to a first aspect of the present disclosure, there is provided data used for machine learning of a model, the training data comprising an example image determined by assuming a captured image obtained by imaging a subject, and a correct answer image, in which the example image is an image represented by a plurality of first signal values indicating three primary colors of light, the correct answer image is an image represented by a plurality of second signal values indicating the three primary colors, the plurality of first signal values are saturated in order in accordance with an increase in brightness of the subject, and at least two of the plurality of second signal values are increased in accordance with an increase in the brightness of the subject without being saturated in a low brightness region and a medium brightness region among the low brightness region of the subject, the medium brightness region of the subject, and a high brightness region of the subject.

According to a second aspect of the present disclosure, in the training data according to the first aspect, the plurality of first signal values are saturated in an order corresponding to a color of the subject in accordance with an increase in the brightness of the subject.

According to a third aspect of the present disclosure, in the training data according to the first or second aspect, the example image and the correct answer image are images generated based on a standard image indicating the subject, the standard image is an image represented by a plurality of third signal values indicating the three primary colors, and the plurality of third signal values are increased at a constant ratio in accordance with an increase in the brightness of the subject.

According to a fourth aspect of the present disclosure, in the training data according to the third aspect, a ratio at which the plurality of first signal values are increased in accordance with an increase in the brightness of the subject is higher than the ratio at which the plurality of third signal values are increased in accordance with an increase in the brightness of the subject.

According to a fifth aspect of the present disclosure, in the training data according to the third or fourth aspect, the example image is an image obtained by increasing a gain of the standard image.

According to a sixth aspect of the present disclosure, in the training data according to any one of the third to fifth aspects, the correct answer image is an image obtained by increasing a gain of the standard image, maintaining a magnitude relationship among the plurality of third signal values in the low brightness region, the medium brightness region, and the high brightness region, and saturating at least two of the plurality of third signal values in the high brightness region without saturating the at least two of the plurality of third signal values in the low brightness region and the medium brightness region, and an amount of increase in the gain varies depending on the brightness of the subject.

According to a seventh aspect of the present disclosure, there is provided a trained model obtained by optimizing the model by performing the machine learning on the model using the training data according to any one of the first to sixth aspects.

According to an eighth aspect of the present disclosure, there is provided an image processing device comprising a first processor, in which the first processor is configured to acquire the captured image and a first image output from the trained model according to the seventh aspect by inputting an image for inference into the trained model, and generate a second image by blending the first image and the captured image.

According to a ninth aspect of the present disclosure, in the image processing device according to the eighth aspect, the first processor is configured to generate the second image by blending the first image and the captured image in units of standard regions.

According to a tenth aspect of the present disclosure, in the image processing device according to the ninth aspect, the first processor is configured to generate the second image by blending the first image and the captured image in accordance with a blending ratio determined in units of the standard regions, the blending ratio is a value based on at least one of a first blending ratio, a second blending ratio, or a third blending ratio, the first blending ratio is determined in accordance with a classification result obtained by performing object classification processing on the captured image or the first image in units of the standard regions using an AI, the second blending ratio is determined in accordance with a highest signal value among a plurality of fourth signal values indicating the three primary colors in units of the standard regions for the second image, and the third blending ratio is determined in accordance with a lowest signal value among the plurality of fourth signal values.

According to an eleventh aspect of the present disclosure, there is provided an imaging apparatus comprising a second processor, and an image sensor, in which the second processor is configured to input an image for inference into the trained model according to the seventh aspect, and acquire an inference result output from the trained model in accordance with input of the image for inference, and the captured image is obtained by imaging the subject via the image sensor.

According to a twelfth aspect of the present disclosure, there is provided a learning device comprising a third processor, in which the third processor is configured to optimize the model by performing the machine learning on the model using the training data according to any one of the first to sixth aspects.

According to a thirteenth aspect of the present disclosure, there is provided a method of creating training data used for machine learning of a model, the training data including an example image determined by assuming a captured image obtained by imaging a subject, and a correct answer image, the method comprising creating the correct answer image, and creating the example image, in which the example image is an image represented by a plurality of first signal values indicating three primary colors of light, the correct answer image is an image represented by a plurality of second signal values indicating the three primary colors, the plurality of first signal values are saturated in order in accordance with an increase in brightness of the subject, and at least two of the plurality of second signal values are increased in accordance with an increase in the brightness of the subject without being saturated in a low brightness region and a medium brightness region among the low brightness region of the subject, the medium brightness region of the subject, and a high brightness region of the subject.

According to a fourteenth aspect of the present disclosure, there is provided a method of generating a trained model by performing machine learning on a model using training data, the training data including a correct answer image, and an example image determined by assuming a captured image obtained by imaging a subject, the example image being an image represented by a plurality of first signal values indicating three primary colors of light, the correct answer image being an image represented by a plurality of second signal values indicating the three primary colors, the plurality of first signal values being saturated in order in accordance with an increase in brightness of the subject, and at least two of the plurality of second signal values being increased in accordance with an increase in the brightness of the subject without being saturated in a low brightness region and a medium brightness region among the low brightness region of the subject, the medium brightness region of the subject, and a high brightness region of the subject, the method comprising inputting the example image into the model, outputting an evaluation target image in accordance with input of the example image via the model, and optimizing the model based on a comparison result between the evaluation target image and the correct answer image.

According to a fifteenth aspect of the present disclosure, there is provided an image processing method comprising acquiring the captured image and a first image output from the trained model according to the seventh aspect by inputting an image for inference into the trained model, and generating a second image by blending the first image and the captured image.

According to a sixteenth aspect of the present disclosure, there is provided an inference method comprising inputting an image for inference into the trained model according to the seventh aspect, and acquiring an inference result output from the trained model in accordance with input of the image for inference.

According to a seventeenth aspect of the present disclosure, there is provided a program causing a computer to execute a process comprising acquiring the captured image and a first image output from the trained model according to the seventh aspect by inputting an image for inference into the trained model, and generating a second image by blending the first image and the captured image.

According to an eighteenth aspect of the present disclosure, there is provided a program causing a computer to execute a process comprising inputting an image for inference into the trained model according to the seventh aspect, and acquiring an inference result output from the trained model in accordance with input of the image for inference.

### BRIEF DESCRIPTION OF THE DRAWINGS

Exemplary embodiments of the technology of the disclosure will be described in detail based on the following figures, wherein:

FIG. 1 is a conceptual diagram illustrating an example of an aspect in which an imaging apparatus is used;

FIG. 2 is a block diagram illustrating an example of a hardware configuration of an electrical system of the imaging apparatus, an example of a main function, and an example of a color signal value representing a part of an image region included in a captured image;

FIG. 3 is a conceptual diagram illustrating an example of a configuration of a learning device;

FIG. 4 is a conceptual diagram illustrating an example of a method of creating an example image;

FIG. 5 is a conceptual diagram illustrating an example of a method of creating a correct answer image;

FIG. 6 is a conceptual diagram illustrating an example of a method of generating a high image quality image;

FIG. 7 is a flowchart illustrating an example of a flow of learning processing;

FIG. 8 is a flowchart illustrating an example of a flow of image quality enhancement processing;

FIG. 9 is a conceptual diagram illustrating a first modification example of a color signal value representing the correct answer image;

FIG. 10 is a conceptual diagram illustrating a second modification example of the color signal value representing the correct answer image;

FIG. 11 is a conceptual diagram illustrating a modification example of the method of generating the high image quality image;

FIG. 12 is a conceptual diagram illustrating an example of content of a first blending ratio table, a second blending ratio table, and a third blending ratio table;

FIG. 13 is a conceptual diagram illustrating an example of a method of calculating a blending ratio used for blending a captured image and an AI image; and

FIG. 14 is a conceptual diagram illustrating an example of a form in which the image quality enhancement processing is performed by an external apparatus in response to a request of the imaging apparatus, and a processing result is received by the imaging apparatus.

### DETAILED DESCRIPTION

Hereinafter, an example of embodiments of training data, an image processing device, an imaging apparatus, a learning device, a method of creating training data, a method of generating a trained model, an image processing method, an inference method, and a program according to the present disclosure will be described with reference to the accompanying drawings.

First, terms used in the following description will be described.

CPU refers to the abbreviation for “Central Processing Unit”. GPU refers to the abbreviation for “Graphics Processing Unit”. GPGPU refers to the abbreviation for “General-Purpose computing on Graphics Processing Units”. APU refers to the abbreviation for “Accelerated Processing Unit”. TPU refers to the abbreviation for “Tensor Processing Unit”. NVM refers to the abbreviation for “Non-Volatile Memory”. RAM refers to the abbreviation for “Random Access Memory”. IC refers to the abbreviation for “Integrated Circuit”. ASIC refers to the abbreviation for “Application Specific Integrated Circuit”. PLD refers to the abbreviation for “Programmable Logic Device”. FPGA refers to the abbreviation for “Field-Programmable Gate Array”. SoC refers to the abbreviation for “System-on-a-Chip”. SSD refers to the abbreviation for “Solid State Drive”. USB refers to the abbreviation for “Universal Serial Bus”. EEPROM refers to the abbreviation for “Electrically Erasable and Programmable Read Only Memory”. I/F refers to the abbreviation for “Interface”. UI refers to the abbreviation for “User Interface”. CMOS refers to the abbreviation for “Complementary Metal Oxide Semiconductor”. CCD refers to the abbreviation for “Charge Coupled Device”. AI refers to the abbreviation for “Artificial Intelligence”.

In the following description, a processor with a reference numeral (hereinafter, simply referred to as the “processor”) may be one physical or virtual operation device or a combination of a plurality of physical or virtual operation devices. The processor may be one type of operation device or a combination of a plurality of types of operation devices. Examples of the operation device include a CPU, a GPU, a GPGPU, an APU, or a TPU.

In the following description, a memory with a reference numeral is a memory such as a RAM temporarily storing information and is used as a work memory by the processor.

In the following description, a storage with a reference numeral is one or a plurality of non-volatile storage devices storing various programs and various parameters or the like. Examples of the non-volatile storage device include a flash memory, a magnetic disk, or a magnetic tape. Other examples of the storage include a cloud storage.

In the following embodiment, an external I/F with a reference numeral controls exchange of various types of information among a plurality of apparatuses connected to each other. Examples of the external I/F include a USB interface. A communication I/F including a communication processor and an antenna or the like may be applied to the external I/F. The communication I/F controls communication among a plurality of computers. Examples of a communication standard applied to the communication I/F include a wireless communication standard including 5G, Wi-Fi (registered trademark), or Bluetooth (registered trademark).

In the following embodiment, “A and/or B” is synonymous with “at least one of A or B”. That is, “A and/or B” may mean only A, only B, or a combination of A and B. In the present specification, the same approach as “A and/or B” also applies to an expression of three or more matters connected with “and/or”.

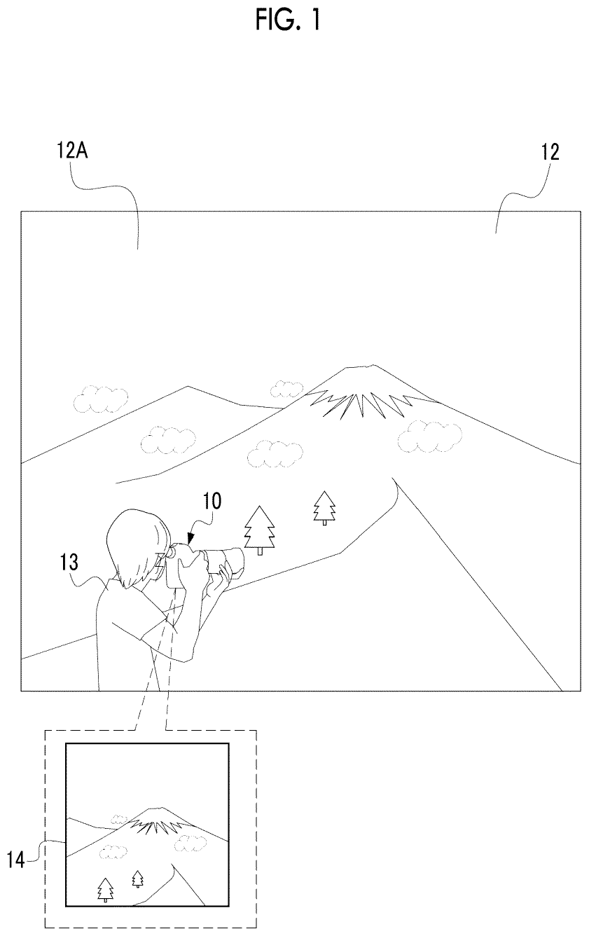

For example, as illustrated in FIG. 1, an imaging apparatus 10 images an imaging target region 12 designated as a subject. The imaging target region 12 is determined by an angle of view designated by an imaging person 13 who is a user of the imaging apparatus 10. In the example illustrated in FIG. 1, the imaging target region 12 includes a cloud, a mountain, a tree, a road, and the like in addition to a blue sky 12A. In the present embodiment, the imaging apparatus 10 is an example of an “imaging apparatus” according to the present disclosure.

The imaging apparatus 10 generates a captured image 14 indicating the imaging target region 12 by imaging the imaging target region 12 in accordance with an instruction provided from the imaging person 13. In the present embodiment, the imaging target region 12 is an example of a “subject” according to the present disclosure, and the captured image 14 is an example of a “captured image” according to the present disclosure.

The imaging apparatus 10 is a digital camera for consumer use. Examples of the digital camera for consumer use include a lens-interchangeable digital camera or a lens-fixed digital camera. The digital camera for consumer use is merely an example. The present disclosure is also established in a case where the imaging apparatus 10 is a digital camera for industrial use. The present disclosure is also established in a case where the imaging apparatus 10 is an imaging apparatus mounted on various electronic apparatuses such as a driving recorder, a smart device, a wearable terminal, an endoscope apparatus, a cell observation apparatus, an ophthalmic observation apparatus, or a surgical microscope.

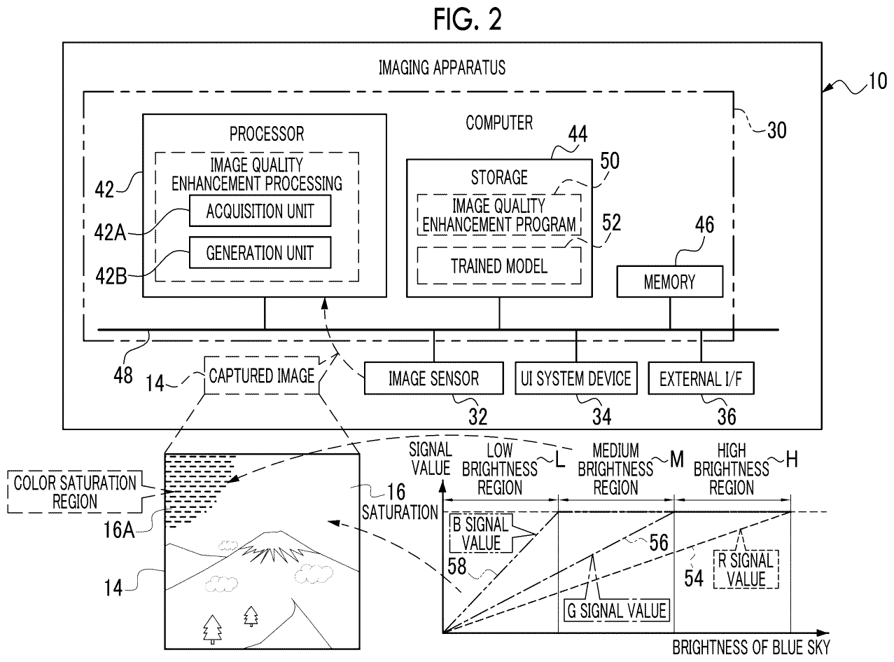

For example, as illustrated in FIG. 2, the imaging apparatus 10 comprises a computer 30, an image sensor 32, a UI system device 34, and an external I/F 36. In the present embodiment, the image sensor 32 is an example of an “image sensor” according to the present disclosure, and the computer 30 is an example of an “image processing device” and a “computer” according to the present disclosure.

The computer 30 comprises a processor 42, a storage 44, and a memory 46. The processor 42, the storage 44, and the memory 46 are connected to a bus 48. In the present embodiment, the processor 42 is an example of a “first processor” and a “second processor” according to the present disclosure.

The storage 44 is a non-volatile storage device (that is, a computer-readable non-transitory storage medium) storing various programs and various parameters or the like. Examples of the storage 44 include a flash memory (for example, an EEPROM). The memory 46 is a storage region in which information is temporarily stored, and is used as a work memory by the processor 42. Examples of the memory 46 include a RAM.

The image sensor 32 includes a plurality of photosensitive pixels (not illustrated) disposed in a matrix. Each photosensitive pixel is a physical pixel including a photodiode (not illustrated), photoelectrically converts received light, and outputs an electrical signal corresponding to a quantity of the received light. In the plurality of photosensitive pixels, color filters (not illustrated) of three primary colors of light, that is, a red color (hereinafter, referred to as “R”), a green color (hereinafter, referred to as “G”), or a blue color (hereinafter, referred to as “B”), are disposed in a predetermined pattern arrangement. In the present embodiment, a Bayer arrangement is used as an example of the predetermined pattern arrangement. However, the Bayer arrangement is merely an example. The present disclosure is also established in a case where the predetermined pattern arrangement is other types of pattern arrangements such as a G stripe R/G full checkered arrangement, an X-Trans (registered trademark) arrangement, or a honeycomb arrangement.

Hereinafter, for convenience of description, a photosensitive pixel including a microlens and a color filter of R will be referred to as an “R photosensitive pixel”, a photosensitive pixel including a microlens and a color filter of G will be referred to as a “G photosensitive pixel”, and a photosensitive pixel including a microlens and a color filter of B will be referred to as a “B photosensitive pixel”. Hereinafter, for convenience of description, an electrical signal output from the R photosensitive pixel will be referred to as an “R signal” or a “color signal of R”, an electrical signal output from the G photosensitive pixel will be referred to as a “G signal” or a “color signal of G”, and an electrical signal output from the B photosensitive pixel will be referred to as a “B signal” or a “color signal of B”. Hereinafter, for convenience of description, the color signal of R, the color signal of G, and the color signal of B will be referred to as “color signals” unless necessary to distinguish therebetween. Hereinafter, for convenience of description, a signal value of the R signal will be referred to as an “R signal value”, a signal value of the G signal will be referred to as a “G signal value”, and a signal value of the B signal will be referred to as a “B signal value”. The R signal value, the G signal value, and the B signal value will be referred to as “color signal values” unless necessary to distinguish therebetween.

The image sensor 32 is connected to the bus 48, and the image sensor 32 generates the captured image 14 by imaging the imaging target region 12 (refer to FIG. 1) under control of the processor 42. The captured image 14 is an image of an RGB format and is formed with a pixel of R (hereinafter, referred to as an “R pixel”), a pixel of G (hereinafter, referred to as a “G pixel”), and a pixel of B (hereinafter, referred to as a “B pixel”).

Examples of the image sensor 32 include a CMOS image sensor. While a CMOS image sensor is illustrated as an example of the image sensor 32, this is merely an example. The image sensor 32 may be other types of image sensors such as a CCD image sensor.

The UI system device 34 is connected to the bus 48. The UI system device 34 receives an instruction from the imaging person 13 (refer to FIG. 1) and outputs a signal indicating the received instruction to the processor 42. The UI system device 34 presents various types of information to the imaging person 13 under control of the processor 42. For example, presentation of the various types of information is implemented by displaying the various types of information on a display or outputting the various types of information from a speaker as a voice.

The external I/F 36 controls exchange of various types of information with an apparatus present outside the imaging apparatus 10 (hereinafter, referred to as an “external apparatus”). Examples of the external I/F 36 include a USB interface. The external apparatus (not illustrated) such as a smart device, a personal computer, a server, a USB memory, a memory card, and/or a printer is directly or indirectly connected to the USB interface.

The captured image 14 includes an image region 16 indicating the blue sky 12A (refer to FIG. 1). A brightness region (in other words, a brightness range) of the image region 16 is divided into a high brightness region H, a medium brightness region M, and a low brightness region L. In the example illustrated in FIG. 2, the brightness region of the image region 16 is divided into three regions of the high brightness region H, the medium brightness region M, and the low brightness region L at equal intervals. The high brightness region H is a region of high brightness (in other words, a range of high brightness) in the image region 16. The medium brightness region M is a region of medium brightness (in other words, a range of medium brightness) in the image region 16. The low brightness region L is a region of low brightness (in other words, a range of low brightness) in the image region 16. While the brightness range of the image region 16 has been illustratively described for convenience of description, the brightness region is also defined for an image region other than the image region 16 (that is, an image region indicating a subject other than the blue sky 12A). A color of the image region other than the image region 16 is also represented by the R signal value, the G signal value, and the B signal value.

The image region 16 is an image region represented by an R signal value 54, a G signal value 56, and a B signal value 58. That is, a color of the image region 16 is represented by the R signal value 54, the G signal value 56, and the B signal value 58. The R signal value 54, the G signal value 56, and the B signal value 58 are saturated in an order corresponding to the color of the image region 16 (that is, a color of the blue sky 12A) in accordance with an increase in brightness of the image region 16. In the present embodiment, the R signal value 54, the G signal value 56, and the B signal value 58 representing the captured image 14 are an example of a “plurality of fourth signal values” according to the present disclosure.

In the low brightness region L, a magnitude relationship among the R signal value 54, the G signal value 56, and the B signal value 58 is “B signal value 58>G signal value 56>R signal value 54”. In the low brightness region L, the R signal value 54, the G signal value 56, and the B signal value 58 are increased at a constant ratio in accordance with an increase in the brightness of the image region 16. The B signal value 58 is saturated at a boundary position between the low brightness region L and the medium brightness region M.

Even in the medium brightness region M, the magnitude relationship among the R signal value 54, the G signal value 56, and the B signal value 58 is “B signal value 58>G signal value 56>R signal value 54”. In the medium brightness region M, the B signal value 58 is maintained in its saturation state. The G signal value 56 and the B signal value 58 are increased at the same ratio as that in the low brightness region L. The G signal value 56 is saturated at a boundary position between the medium brightness region M and the high brightness region H.

In the high brightness region H, the B signal value 58 and the G signal value 56 are maintained in its saturation state. The R signal value 54 continues increasing while maintaining its ratio of increase in the low brightness region L and the medium brightness region M and is saturated at upper limit brightness of the high brightness region H. In the example illustrated in FIG. 2, the saturation state of the B signal value 58 is maintained from the boundary position between the low brightness region L and the medium brightness region M to the upper limit brightness of the high brightness region H. The saturation state of the G signal value 56 is maintained from the boundary position between the medium brightness region M and the high brightness region H to the upper limit brightness of the high brightness region H.

As described above, in a case where the B signal value 58 and the G signal value 56 are saturated at lower brightness than the R signal value 54, a color saturation region 16A occurs in the image region 16. The color saturation region 16A is a region (for example, a region in which white is dominant over other colors) represented by a color that is not the original color of the blue sky 12A (for example, a color perceived with the naked eye by a person having general visibility).

For example, in a case where blue is to be originally represented in the color saturation region 16A, cyan is represented in the color saturation region 16A because the B signal value 58 is saturated on a low brightness side with respect to other color signal values from the boundary position between the low brightness region L and the medium brightness region M to the high brightness region H. In a case where blue, cyan, or a medium color between blue and cyan is to be originally represented in the color saturation region 16A, washing out occurs in the color saturation region 16A because the G signal value 56 is saturated on a low brightness side with respect to the R signal value 54 from the boundary position between the medium brightness region M and the high brightness region H to the high brightness region H.

While color reproducibility of the blue sky 12A has been illustratively described, the same applies to a subject other than the blue sky 12A. For example, even in an image obtained by imaging a handrail of an orange color, an image region in which the color signal values are saturated may occur based on the same principle as the color saturation region 16A. A magnitude relationship between the color signal values representing the image region indicating the handrail of the orange color is “R signal value 54>G signal value 56>B signal value 58”. The R signal value 54 is saturated on a low brightness side with respect to the G signal value 56 and the B signal value 58, and the G signal value 56 is saturated on a low brightness side with respect to the B signal value 58. Thus, washing out occurs based on the same principle as the color saturation region 16A.

Therefore, in order to set the color reproducibility of the subject captured in the captured image 14 to the same level as the color of the subject in a real space (that is, in order to represent the original color of the subject on the image), the processor 42 performs image quality enhancement processing in the present embodiment. In order to implement the image quality enhancement processing, an image quality enhancement program 50 and a trained model 52 are stored in the storage 44. The image quality enhancement program 50 is an example of a “program” according to the present disclosure.

The processor 42 reads out the image quality enhancement program 50 from the storage 44 and executes the read image quality enhancement program 50 on the memory 46.

The image quality enhancement processing is implemented by causing the processor 42 to operate as an acquisition unit 42A and a generation unit 42B in accordance with the image quality enhancement program 50 executed on the memory 46. As will be described in detail later, the trained model 52 is used by the acquisition unit 42A.

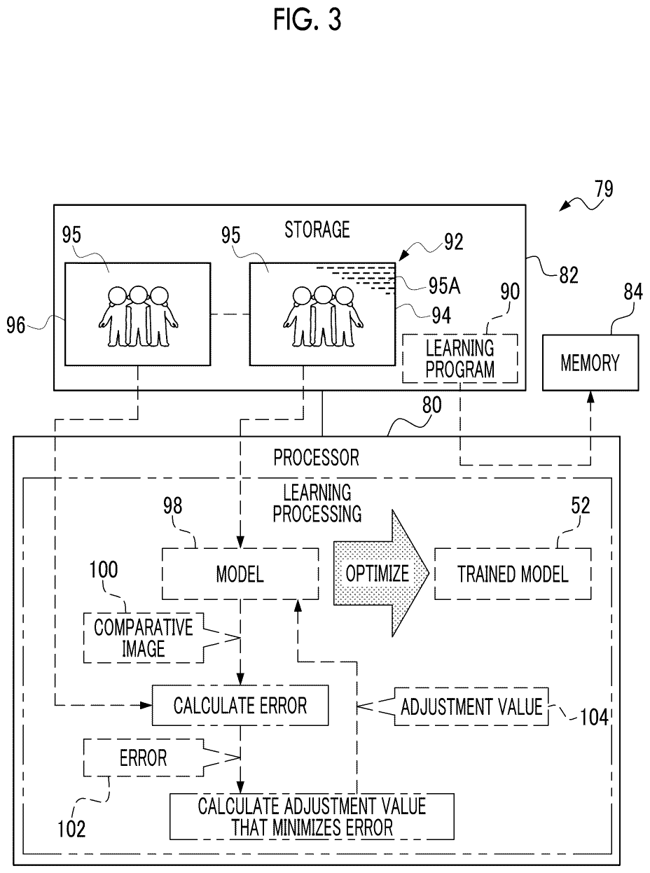

Next, an example of a method of generating the trained model 52 will be described with reference to FIGS. 3 to 5.

For example, as illustrated in FIG. 3, a learning device 79 comprises a processor 80, a storage 82, and a memory 84. A hardware configuration of the learning device 79 (for example, the processor 80, the storage 82, and the memory 84) is basically the same as a hardware configuration of the computer 30 illustrated in FIG. 2. Thus, description related to the hardware configuration of the learning device 79 will be omitted. In the present embodiment, the processor 80 is an example of a “third processor” according to the present disclosure, and the learning device 79 is an example of a “learning device” according to the present disclosure.

A learning program 90 is stored in the storage 82. The processor 80 reads out the learning program 90 from the storage 82 and executes the read learning program 90 on the memory 84. The processor 80 performs learning processing in accordance with the learning program 90 executed on the memory 84. The learning processing is processing of generating the trained model 52 from a model 98. The trained model 52 is generated by executing machine learning on the model 98 via the processor 80. That is, the trained model 52 is generated by optimizing the model 98 through the machine learning. For example, the model 98 is a neural network having several hundred million to several trillion interlayers. Examples of the model 98 include a model for a generative AI that generates and outputs an image obtained by enhancing image quality of an input image (for example, an image in which at least the color saturation region 16A (refer to FIG. 2) is suppressed).

The storage 82 stores a plurality of (for example, several ten thousand to several hundred billion) pieces of training data 92. The training data 92 is used for the machine learning of the model 98. That is, in the learning device 79, the processor 80 acquires the plurality of pieces of training data 92 from the storage 82 and generates the trained model 52 by optimizing the model 98 by performing the machine learning on the model 98 using the acquired plurality of pieces of training data 92.

The training data 92 is labeled data. For example, the labeled data is data in which an example image 94 (in other words, example data) and a correct answer image 96 (in other words, correct answer data) are associated with each other. The training data 92 is an example of “training data” according to the present disclosure. The example image 94 is an example of an “example image” according to the present disclosure. The correct answer image 96 is an example of a “correct answer image” according to the present disclosure.

The example image 94 is an image of the RGB format determined by assuming the captured image 14. In the example illustrated in FIG. 3, the example image 94 includes an image region 95 that assumes the image region 16 illustrated in FIG. 2 as an image region indicating the blue sky. The image region 95 includes a color saturation region 95A that assumes the color saturation region 16A illustrated in FIG. 2.

In the present embodiment, an image generated based on an image obtained by actually imaging a sample subject (for example, a subject captured in the correct answer image 96 illustrated in FIG. 3) via an imaging apparatus (for example, an imaging apparatus of the same type and the same specifications as the imaging apparatus 10) is used as the example image 94. However, this is merely an example. The image assuming the captured image 14 obtained by performing imaging via the imaging apparatus 10 may be a virtually generated image. Examples of the virtually generated image include an image generated by a generative AI. The generative AI may be an AI specialized in generating an image or a generative AI that generates and outputs the example image 94 in accordance with input instruction data (a so-called prompt), such as ChatGPT using GPT-4 (searched on the internet <https://openai.com/gpt-4>) or the like.

The correct answer image 96 is an image of the RGB format, like the example image 94. The correct answer image 96 is an image having enhanced image quality compared to the example image 94. Examples of the image having enhanced image quality include an image in which the color saturation region 95A of the example image 94 is suppressed (for example, an image that includes the image region 95 in which the color saturation region 95A is eliminated and that is the same as the example image 94 except for the image region 95).

The processor 80 acquires the training data 92 one piece at a time from the storage 82. The processor 80 inputs the example image 94 into the model 98 from the training data 92 acquired from the storage 82. In a case where the example image 94 is input, the model 98 generates a comparative image 100 that is an image having enhanced image quality compared to the example image 94 (for example, an image in which the color saturation region 95A is suppressed). The comparative image 100 is an image used to be compared with the correct answer image 96 associated with the example image 94 input into the model 98. The comparative image 100 is an example of an “evaluation target image” according to the present disclosure.

The processor 80 calculates an error 102 between the correct answer image 96 associated with the example image 94 input into the model 98 and the comparative image 100. The error 102 is an example of a “comparison result” according to the present disclosure.

The processor 80 calculates a plurality of adjustment values 104 that minimize the error 102. The processor 80 adjusts a plurality of optimization variables in the model 98 using the plurality of adjustment values 104. For example, the plurality of optimization variables refer to a plurality of connection weights and a plurality of offset values included in the model 98.

The processor 80 repeats the series of processing of inputting the example image 94 into the model 98, calculating the error 102, calculating the plurality of adjustment values 104, and adjusting the plurality of optimization variables in the model 98, using the plurality of pieces of training data 92 stored in the storage 82. That is, the processor 80 optimizes the model 98 by adjusting the plurality of optimization variables in the model 98 using the plurality of adjustment values 104 that are calculated such that the error 102 is minimized for each of a plurality of example images 94 included in the plurality of pieces of training data 92 stored in the storage 82. The processor 80 generates the trained model 52 by optimizing the model 98. In a case where the example image 94 is input into the trained model 52 generated as described above, the trained model 52 generates and outputs an image having the same image quality as the correct answer image 96 (that is, an image in which the color saturation region 95A is suppressed to the same level as the correct answer image 96) as an image corresponding to the input example image 94.

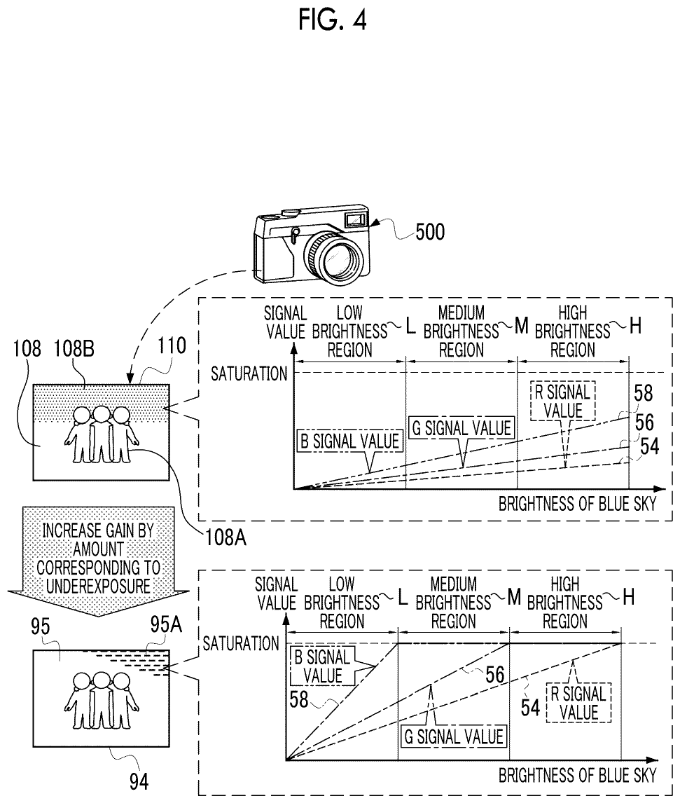

FIG. 4 is a conceptual diagram illustrating an example of a method of creating the example image 94. As illustrated in FIG. 4, the example image 94 is an image generated based on a standard image 110. The standard image 110 is an image obtained by imaging a subject 108 including a person 108A and a blue sky 108B or the like via a standard imaging apparatus 500 (for example, an imaging apparatus of the same type and the same specifications as the imaging apparatus 10) with underexposure so that the color signal values are not saturated. The standard image 110 is an image of the RGB format and is represented by the color signal values. The R signal value 54, the G signal value 56, and the B signal value 58 representing the standard image 110 are increased at a constant ratio in accordance with an increase in brightness of the subject 108. The R signal value 54, the G signal value 56, and the B signal value 58 representing the blue sky 108B captured in the standard image 110 are monotonically increased without being saturated from the low brightness region L to the high brightness region H. For the color signal values of an image region indicating the blue sky 108B, a magnitude relationship of “B signal value 58>G signal value 56>R signal value 54” is established. In the example illustrated in FIG. 4, the R signal value 54, the G signal value 56, and the B signal value 58 representing the standard image 110 are an example of a “plurality of third signal values indicating three primary colors” according to the present disclosure.

The example image 94 is an image represented by the R signal value 54, the G signal value 56, and the B signal value 58. That is, a color of the example image 94 is represented by the R signal value 54, the G signal value 56, and the B signal value 58. The example image 94 is obtained by increasing gains (that is, digital gains) of the R signal value 54, the G signal value 56, and the B signal value 58 at a uniform ratio of increase (for example, a ratio of increase determined in accordance with the subject (for example, the blue sky 108B) captured in the standard image 110) by an amount corresponding to the underexposure performed by the standard imaging apparatus 500 in imaging for obtaining the standard image 110. In a case where the color signal values are caused to exceed a saturation value (for example, 255) by applying the gains, the color signal values are clipped at the saturation value. The R signal value 54, the G signal value 56, and the B signal value 58 representing the example image 94 are saturated in order in accordance with an increase in brightness of the subject (for example, brightness of the blue sky 108B). In the example illustrated in FIG. 4, the color signal values are saturated in an order of the B signal value 58, the G signal value 56, and the R signal value 54.

In the present embodiment, the blue sky 108B is purposely imaged with underexposure by the standard imaging apparatus 500. This is intended not to saturate the color signal values. Therefore, in the present embodiment, in creating the example image 94 based on the standard image 110, a ratio among the R signal value 54, the G signal value 56, and the B signal value 58 representing the image region 95 included in the example image 94 (for example, a ratio at which the R signal value 54, the G signal value 56, and the B signal value 58 in the low brightness region L are increased in accordance with the brightness of the subject) is set to be higher than a ratio among the R signal value 54, the G signal value 56, and the B signal value 58 representing the blue sky 108B captured in the standard image 110 (that is, a ratio at which the R signal value 54, the G signal value 56, and the B signal value 58 representing the blue sky 108B captured in the standard image 110 are increased in accordance with the brightness of the subject) by increasing the gains of the R signal value 54, the G signal value 56, and the B signal value 58 at a uniform ratio of increase by the amount corresponding to the underexposure.

Accordingly, the same ratio as the ratio among the R signal value 54, the G signal value 56, and the B signal value 58 (for example, the ratio in the low brightness region L) representing the captured image 14 (refer to FIGS. 1 and 2) obtained by imaging the blue sky 12A (refer to FIG. 1) via the imaging apparatus 10 under an actual imaging condition is implemented as the ratio among the R signal value 54, the G signal value 56, and the B signal value 58 (for example, the ratio in the low brightness region L) representing the image region 95. In the example illustrated in FIG. 4, the R signal value 54, the G signal value 56, and the B signal value 58 representing the image region 95 included in the example image 94 behave in the same manner as the R signal value 54, the G signal value 56, and the B signal value 58 representing the image region 16 illustrated in FIG. 2 with respect to the brightness of the subject captured in the example image 94 (for example, the brightness of the blue sky).

That is, the R signal value 54, the G signal value 56, and the B signal value 58 representing the image region 95 are saturated in an order corresponding to a color of the image region 95 (for example, a color of the blue sky 108B) in accordance with an increase in the brightness of the image region 95. In the image region 95, the B signal value 58, the G signal value 56, and the R signal value 54 are saturated in this order in accordance with an increase in the brightness of the image region 95. In the example illustrated in FIG. 4, the R signal value 54, the G signal value 56, and the B signal value 58 representing the image region 95 included in the example image 94 are an example of a “plurality of first signal values indicating three primary colors of light” according to the present disclosure.

While the blue sky 108B is illustrated, this is merely an example. In a subject other than the blue sky 108B (that is, an image region other than the image region 95), the R signal value 54, the G signal value 56, and the B signal value 58 representing another image region that is an image region other than the image region 95 are also saturated in an order corresponding to a color of the other image region.

While an example of a form in which the standard image 110 is obtained by performing imaging via the standard imaging apparatus 500 is illustrated, this is merely an example. For example, the standard image 110 may be a virtually generated image as an image that assumes an image obtained by imaging the subject 108 via the standard imaging apparatus 500 with underexposure so that the color signal values are not saturated. Examples of the virtually generated image include an image generated by a generative AI. The generative AI may be an AI specialized in generating an image or may be a generative AI that generates and outputs the standard image 110 in accordance with input instruction data (so-called prompt) as in ChatGPT using GPT-4 or the like.

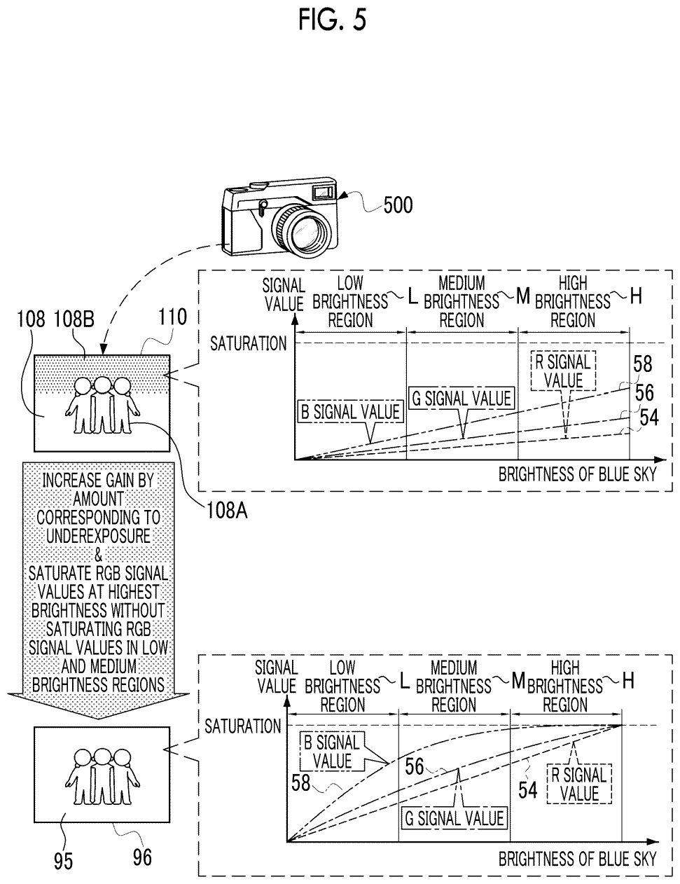

FIG. 5 is a conceptual diagram illustrating an example of a method of creating the correct answer image 96. As illustrated in FIG. 5, the correct answer image 96 is an image generated based on the standard image 110. Like the example image 94, the correct answer image 96 is also an image represented by the R signal value 54, the G signal value 56, and the B signal value 58. That is, a color of the correct answer image 96 is represented by the R signal value 54, the G signal value 56, and the B signal value 58. The R signal value 54, the G signal value 56, and the B signal value 58 representing the correct answer image 96 are increased in accordance with an increase in the brightness of the subject 108 without being saturated in the low brightness region L and the medium brightness region M of the subject 108. The example illustrated in FIG. 5 illustrates an example of a form in which the R signal value 54, the G signal value 56, and the B signal value 58 representing the image region 95 indicating the blue sky 108B in the entire image region of the correct answer image 96 are increased in accordance with an increase in the brightness of the blue sky 108B captured in the correct answer image 96 without being saturated in the low brightness region L and the medium brightness region M. However, this is merely an example, and the same applies to a subject other than the blue sky 108B. The R signal value 54, the G signal value 56, and the B signal value 58 are increased in accordance with an increase in the brightness of the subject increases without being saturated in the low brightness region L and the medium brightness region M. In the present embodiment, the R signal value 54, the G signal value 56, and the B signal value 58 representing the correct answer image 96 are an example of a “plurality of second signal values” according to the present disclosure.

The correct answer image 96 is obtained by increasing the gains of the R signal value 54, the G signal value 56, and the B signal value 58 by the amount corresponding to the underexposure performed by the standard imaging apparatus 500 in imaging for obtaining the standard image 110 and by saturating the color signal values in the high brightness region H without saturating the color signal values in the low brightness region L and the medium brightness region M. An amount of increase in the gains varies depending on the brightness of the subject. An amount of increase derived in advance in accordance with the brightness of the blue sky 108B is used as the amount of increase in the gains by performing an experiment using an actual apparatus and/or a computer simulation or the like. Like the standard image 110, even in the correct answer image 96, the magnitude relationship among the R signal value 54, the G signal value 56, and the B signal value 58 is maintained from the low brightness region L to the high brightness region H. That is, the magnitude relationship of “B signal value 58>G signal value 56>R signal value 54” is maintained among the R signal value 54, the G signal value 56, and the B signal value 58.

While an example of a form in which the magnitude relationship of “B signal value 58>G signal value 56>R signal value 54” is established as a magnitude relationship among the color signal values representing the blue sky 108B is illustrated, this is merely an example. In a subject other than the blue sky 108B, the magnitude relationship among the color signal values is determined in accordance with the color of the subject.

The R signal value 54, the G signal value 56, and the B signal value 58 representing the correct answer image 96 are saturated at the highest brightness of the subject (for example, the highest brightness of the blue sky 108B). In the example illustrated in FIG. 5, the highest brightness of the subject refers to the upper limit brightness of the high brightness region H. The R signal value 54, the G signal value 56, and the B signal value 58 representing the blue sky 108B captured in the correct answer image 96 (that is, the R signal value 54, the G signal value 56, and the B signal value 58 representing the image region 95) are controlled to be washed out at the upper limit brightness of the high brightness region H. The color signal values are classified into a lowest signal value that is the lowest signal value among the color signal values, a highest signal value that is the highest signal value among the color signal values, and a medium signal value that is a signal value between the lowest signal value and the highest signal value among the color signal values. In the example illustrated in FIG. 5, the lowest signal value representing the correct answer image 96 is the R signal value 54. The highest signal value representing the correct answer image 96 is the B signal value 58. The medium signal value representing the correct answer image 96 is the G signal value 56. A ratio at which the R signal value 54 representing the correct answer image 96 is increased with respect to the brightness (that is, the ratio of increase in the R signal value 54) is constant. A ratio at which the G signal value 56 representing the correct answer image 96 is increased with respect to the brightness (that is, the ratio of increase in the G signal value 56) decreases in an order of the low brightness region L, the medium brightness region M, and the high brightness region H. Like the ratio of increase in the G signal value 56, a ratio at which the B signal value 58 representing the correct answer image 96 is increased with respect to the brightness (that is, the ratio of increase in the B signal value 58) also decreases in an order of the low brightness region L, the medium brightness region M, and the high brightness region H.

In the correct answer image 96, in a dark portion (for example, the low brightness region L), the gains of the R signal value 54, the G signal value 56, and the B signal value 58 are increased at a uniform ratio of increase (that is, a ratio of increase determined in accordance with the subject captured in the standard image 110). For example, the gains of the R signal value 54, the G signal value 56, and the B signal value 58 of the dark portion are uniformly increased at a ratio of increase determined in accordance with the blue sky 108B captured in the standard image 110.

In the correct answer image 96, in the medium brightness region M, saturation of the highest signal value (in the example illustrated in FIG. 5, the B signal value 58) is suppressed, and the G signal value 56 and the B signal value 58 are suppressed so that the ratio among the R signal value 54, the G signal value 56, and the B signal value 58 is maintained as far as possible.

While an example of a form in which the correct answer image 96 is generated based on the standard image 110 is illustrated, the correct answer image 96 may be the image virtually generated to satisfy various conditions. Examples of the virtually generated image include an image generated by a generative AI. The generative AI may be an AI specialized in generating an image or may be a generative AI that generates and outputs the correct answer image 96 in accordance with input instruction data (so-called prompt) as in ChatGPT using GPT-4 or the like.

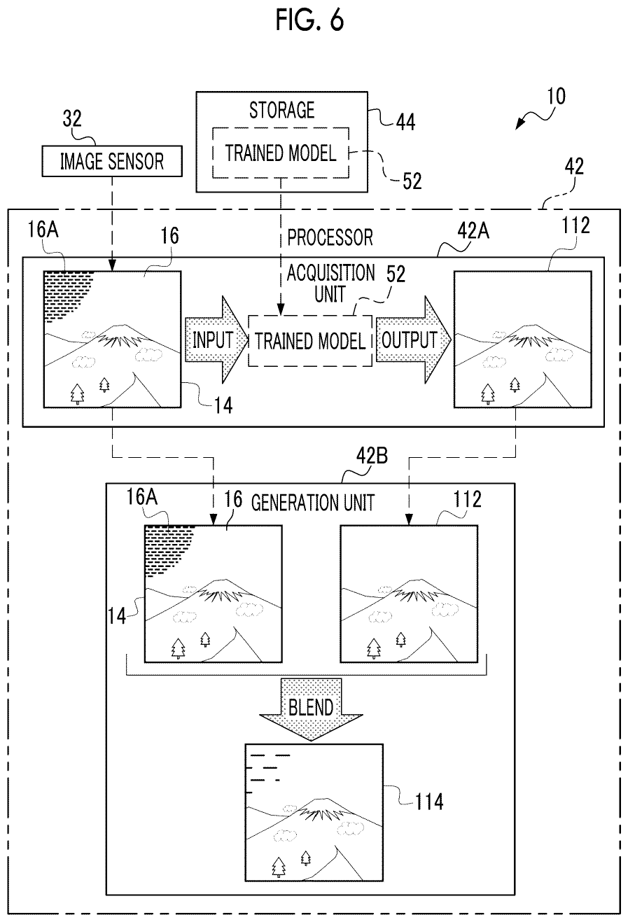

FIG. 6 is a conceptual diagram illustrating an example of an operation phase of the trained model 52 (that is, a phase in which the trained model 52 makes an inference) generated by performing the learning processing in the example illustrated in FIG. 3. As illustrated in FIG. 6, in the imaging apparatus 10, the acquisition unit 42A acquires the captured image 14 from the image sensor 32. The acquisition unit 42A inputs the captured image 14 into the trained model 52 stored in the storage 44, causes the trained model 52 to generate and output an AI image 112, and acquires the AI image 112 output from the trained model 52. The AI image 112 is an image in which the color saturation region 16A of the captured image 14 is suppressed (in the example illustrated in FIG. 6, an image in which the color saturation region 16A is eliminated from the captured image 14). The trained model 52 is an example of a “trained model” according to the present disclosure. The captured image 14 is an example of an “image for inference” according to the present disclosure. The AI image 112 is an example of a “first image” and an “inference result” according to the present disclosure.

The generation unit 42B generates a high image quality image 114 by blending the captured image 14 and the AI image 112. The high image quality image 114 is an image having enhanced image quality compared to the captured image 14. The image having enhanced image quality compared to the captured image 14 refers to an image having enhanced image quality compared to the captured image 14 in terms of suppressing at least the color saturation region 16A of the captured image 14.

The high image quality image 114 is an image generated by blending the captured image 14 and the AI image 112 in units of pixels at positions corresponding to each other. While an example of a form in which the captured image 14 and the AI image 112 are blended in units of pixels at positions corresponding to each other is illustrated, this is merely an example. The captured image 14 and the AI image 112 may be blended in units of blocks (that is, in units of sets of a plurality of pixels) larger than the units of pixels.

For example, blending the captured image 14 and the AI image 112 refers to calculating an arithmetic mean of the captured image 14 and the AI image 112 or blending the captured image 14 and the AI image 112 at a predetermined blending ratio. For example, the blending ratio refers to a ratio at which the AI image 112 and the captured image 14 are added. For example, in a case where the blending ratio is 1:1, half of the color signal values of the AI image 112 and half of the color signal values of the captured image 14 are added in units of pixels. In a case where the blending ratio is 1:0, the color signal values of the AI image 112 are employed in units of pixels, and the color signal values of the captured image 14 are not employed. In a case where the blending ratio is 0:1, the color signal values of the captured image 14 are employed, and the color signal values of the AI image 112 are not employed in units of pixels. In FIG. 6, the high image quality image 114 is an example of a “second image” according to the present disclosure, and the units of pixels are an example of “units of standard regions” according to the present disclosure.

The generation unit 42B converts the high image quality image 114 into a file of a predetermined file format by performing image processing including development on the high image quality image 114 and outputs the file to a predetermined output destination. A first example of the predetermined output destination is the storage 44. A second example of the predetermined output destination is the UI system device 34. A third example of the predetermined output destination is an apparatus (for example, a USB memory, a smart device, a personal computer, and/or a server) connected to the external I/F 36.

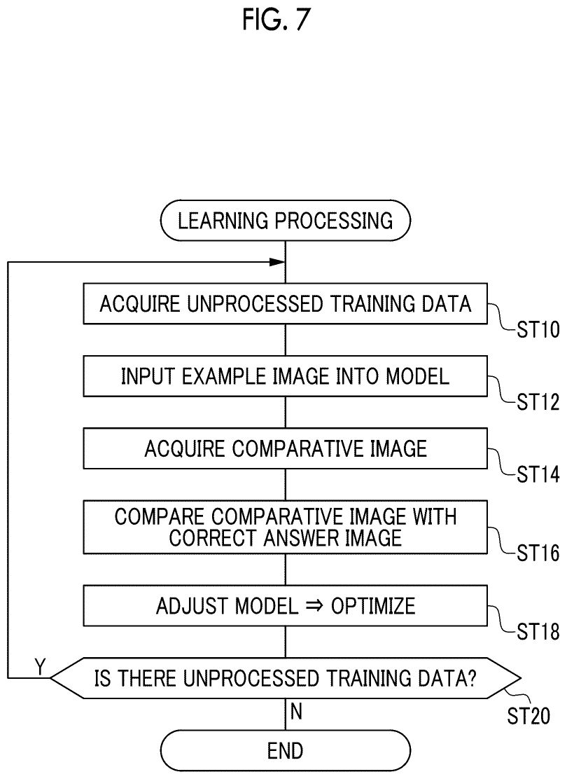

Next, an action of a part of the learning device 79 according to the present disclosure will be described with reference to FIG. 7. FIG. 7 illustrates an example of a flow of the learning processing executed by the processor 80. The flow of learning processing illustrated in FIG. 7 is an example of a “method of generating a trained model” according to the present disclosure.

In the learning processing illustrated in FIG. 7, first, in step ST10, processing of step ST10 in which the processor 80 acquires unprocessed training data 92 (that is, the training data 92 not used in the learning processing illustrated in FIG. 7) from the storage 82 is executed. Then, the learning processing transitions to step ST12.

In step ST12, the processor 80 inputs the example image 94 included in the training data 92 acquired in step ST10 into the model 98. After the processing of step ST12 is executed, the learning processing transitions to step ST14. The comparative image 100 is output from the model 98 by executing the processing of step ST12.

In step ST14, the processor 80 acquires the comparative image 100 output from the model 98. After the processing of step ST14 is executed, the learning processing transitions to step ST16.

In step ST16, the processor 80 compares the comparative image 100 acquired in step ST14 with the correct answer image 96 included in the training data 92 acquired in step ST10. After the processing of step ST16 is executed, the learning processing transitions to step ST18.

In step ST18, the processor 80 adjusts the model 98 using the plurality of adjustment values 104 obtained by comparing the comparative image 100 with the correct answer image 96 in step ST16. The model 98 is optimized by repeatedly executing the processing of step ST18 based on all pieces of the training data 92 stored in the storage 82. After the processing of step ST18 is executed, the learning processing transitions to step ST20.

In step ST20, the processor 80 determines whether or not the unprocessed training data 92 is stored in the storage 82. In step ST20, in a case where the unprocessed training data 92 is stored in the storage 82, a positive determination is made, and the learning processing transitions to step ST10. In step ST20, in a case where the unprocessed training data 92 is not stored in the storage 82, a negative determination is made, and the learning processing is finished.

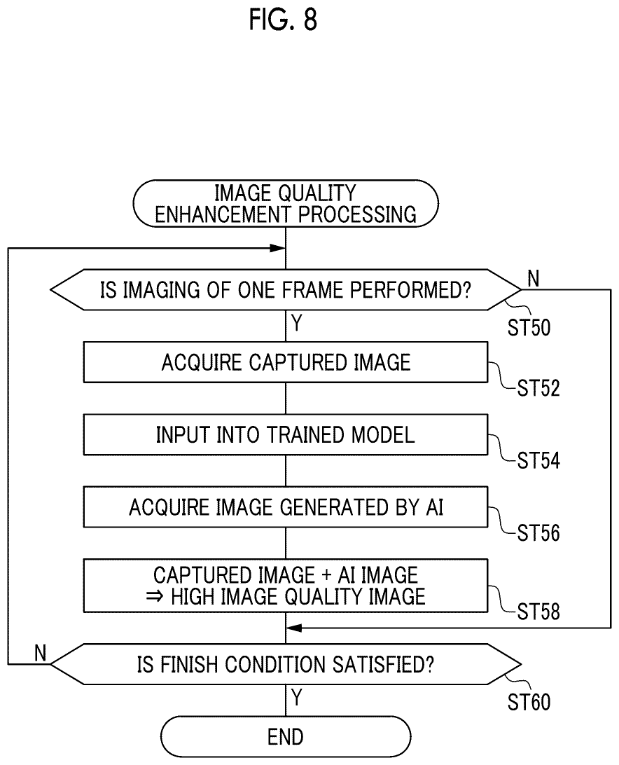

Next, an action of a part of the imaging apparatus 10 according to the present disclosure will be described with reference to FIG. 8. The flow of the image quality enhancement processing illustrated in FIG. 8 is an example of an “inference method” according to the present disclosure. For convenience of description, this description is based on an assumption that the trained model 52 is already stored in the storage 44.

In the image quality enhancement processing illustrated in FIG. 8, first, in step ST50, the acquisition unit 42A determines whether or not imaging of one frame is performed by the image sensor 32. In step ST50, in a case where imaging of one frame is not performed by the image sensor 32, a negative determination is made, and the image quality enhancement processing transitions to step ST58. In a case where imaging of one frame is performed by the image sensor 32, a positive determination is made, and the image quality enhancement processing transitions to step ST52.

In step ST52, the acquisition unit 42A acquires the captured image 14 from the image sensor 32. After the processing of step ST52 is executed, the image quality enhancement processing transitions to step ST54.

In step ST54, the acquisition unit 42A inputs the captured image 14 acquired in step ST52 into the trained model 52. After the processing of step ST54 is executed, the image quality enhancement processing transitions to step ST56. By executing the processing of step ST54, the trained model 52 is caused to generate and output the AI image 112.

In step ST56, the acquisition unit 42A acquires the AI image 112 output from the trained model 52. After the processing of step ST56 is executed, the image quality enhancement processing transitions to step ST58.

In step ST58, the generation unit 42B generates the high image quality image 114 by blending the captured image 14 acquired by the acquisition unit 42A in step ST52 and the AI image 112 acquired by the acquisition unit 42A in step ST54. After the processing of step ST58 is executed, the image quality enhancement processing transitions to step ST60.

In step ST60, the generation unit 42B determines whether or not a condition (hereinafter, referred to as a “finish condition”) under which the image quality enhancement processing is finished is satisfied. Examples of the finish condition include a condition that an instruction to finish the image quality enhancement processing is received by the UI system device 34. In step ST60, in a case where the finish condition is not satisfied, a negative determination is made, and the image quality enhancement processing transitions to step ST50. In step ST60, in a case where the finish condition is satisfied, a positive determination is made, and the image quality enhancement processing is finished.

As described above, the training data 92 according to the present embodiment is used for the machine learning of the model 98. The trained model 52 is generated by performing the machine learning on the model 98. The training data 92 comprises the example image 94 and the correct answer image 96, in which the example image 94 and the correct answer image 96 are associated with each other. The example image 94 is an image determined by assuming the captured image 14, and the color of the example image 94 for each pixel is represented by the color signal values. Like the example image 94, even in the correct answer image 96, the color of the correct answer image 96 for each pixel is represented by the color signal value. The color signal values of the image region 16 (refer to FIG. 2) obtained by imaging the blue sky 12A (refer to FIG. 1) are saturated in an order of the B signal value 58, the G signal value 56, and the R signal value 54 in accordance with an increase in the brightness of the image region 16. The color saturation region 16A occurs in a case where the B signal value 58 and the G signal value 56 are saturated in the medium brightness region M. The color saturation region 16A is an image region that is whiter than the original color of the blue sky 12A (refer to FIG. 1) indicated by the image region 16. Therefore, the color signal values representing the correct answer image 96 included in the training data 92 is configured to be saturated in accordance with an increase in the brightness of the subject (for example, the brightness of the blue sky 108B) without being saturated in the low brightness region L and the medium brightness region M. The trained model 52 obtained by optimizing the model 98 is generated by performing the machine learning on the model 98 using the training data 92 configured as described above. The trained model 52 generates and outputs the AI image 112 in accordance with input of the captured image 14. The AI image 112 is an image having higher color reproducibility of the captured subject than the captured image 14 (that is, an image in which the color saturation region 16A is suppressed). As described above, in a case where the captured image 14 is input into the trained model 52 generated by optimizing the model 98 using the training data 92 according to the present embodiment for the machine learning of the model 98, the trained model 52 can be caused to generate the AI image 112 having higher color reproducibility of the captured subject than the input captured image 14 (that is, an image in which the color saturation region 16A is suppressed).

In the present embodiment, the trained model 52 generated by performing the machine learning on the model 98 using the training data 92 is used by the imaging apparatus 10. Accordingly, the imaging apparatus 10 can generate and output the AI image 112 in which the color saturation region 16A is suppressed compared to that in the captured image 14, by inputting the captured image 14 into the trained model 52.

In the present embodiment, the color signal values representing the example image 94 are saturated in an order corresponding to the color of the subject 108 in accordance with an increase in the brightness of the subject 108. For example, the color signal values representing the example image 94 are saturated in an order of the B signal value 58, the G signal value 56, and the R signal value 54 in accordance with an increase in the brightness of the blue sky 108B. Accordingly, in a case where the captured image 14 is input into the trained model 52 generated by optimizing the model 98 using the training data 92 including the example image 94 configured as described above for the machine learning of the model 98, the trained model 52 can be caused to generate the AI image 112 having higher color reproducibility of the captured subject than the input captured image 14 (that is, an image in which the color saturation region 16A is suppressed).

In the present embodiment, the color signal values representing the standard image 110 are increased at a constant ratio in accordance with an increase in the brightness of the subject 108. The example image 94 and the correct answer image 96 are images generated based on the standard image 110 represented by the same color signal values as the example image 94 and the correct answer image 96. As described above, since the example image 94 and the correct answer image 96 are generated based on an image common to each other, that is, the standard image 110, the example image 94 and the correct answer image 96 can be efficiently generated compared to the example image 94 and the correct answer image 96 that are generated based on different images. The example image 94 and the correct answer image 96 having the same angle of view as the standard image 110 can be easily generated.

In the present embodiment, the constant ratio at which the color signal values representing the standard image 110 are increased is lower than a ratio at which the color signal values representing the example image 94 are increased. Accordingly, the example image 94 that is ideal can be easily generated based on the standard image 110 compared to that in a case where the constant ratio at which the color signal values representing the standard image 110 are increased is higher than the ratio at which the color signal values representing the example image 94 are increased.

In the present embodiment, the example image 94 is generated by increasing the gains of the color signal values representing the standard image 110. Thus, the example image 94 that assumes the captured image 14 can be easily obtained.

In the present embodiment, the correct answer image 96 is generated by increasing the gains of the color signal values representing the standard image 110, maintaining the magnitude relationship among the R signal value 54, the G signal value 56, and the B signal value 58 from the low brightness region L to the high brightness region H, and saturating the color signal values in the high brightness region H without saturating the color signal values in the low brightness region L and the medium brightness region M. The amount of increase in the gains varies depending on the brightness of the subject 108. For example, the amount of increase in the gains used for the blue sky 108B is determined in advance in accordance with the brightness of the blue sky 108B. Thus, the correct answer image 96 in which the color saturation region 95A is suppressed can be easily obtained.

In the present embodiment, the high image quality image 114 is generated by blending the captured image 14 and the AI image 112. The high image quality image 114 is an image in which the color saturation region 16A is suppressed compared to that in the captured image 14. The AI image 112 is an image in which the color saturation region 16A is suppressed compared to that in the high image quality image 114. However, in a case where a component of the color saturation region 16A is excessively small, the original color of the imaging target region 12 (the blue sky 12A) is not easily reproduced. Thus, in the present embodiment, the captured image 14 and the AI image 112 are blended in order to slightly leave the component of the color saturation region 16A. Accordingly, the high image quality image 114 close to the actual color of the imaging target region 12 can be obtained. Since the captured image 14 and the AI image 112 are blended in units of pixels at positions corresponding to each other, the high image quality image 114 close to the actual color of the imaging target region 12 can be obtained compared to that in a case where blending is not performed in units of pixels.

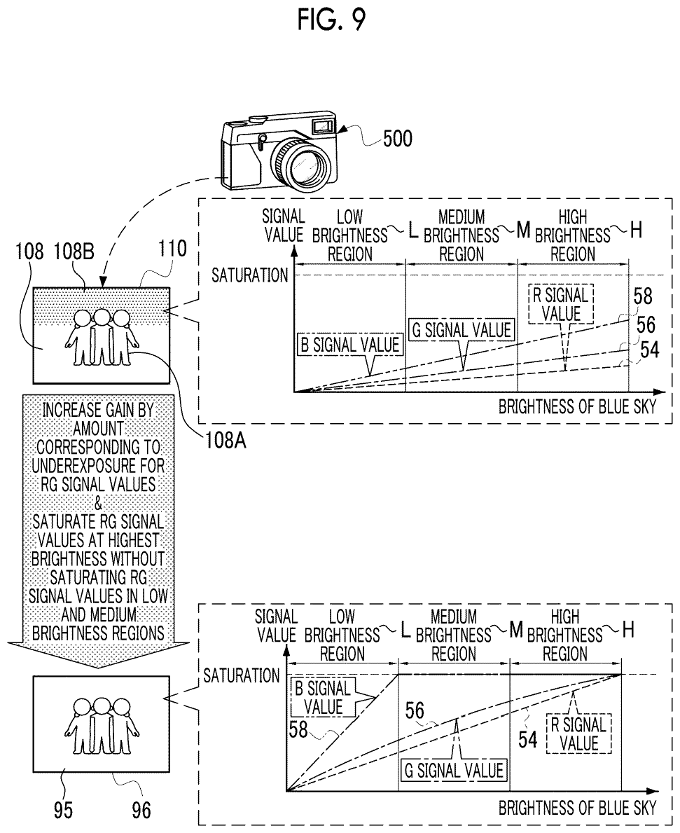

In the embodiment, an example of a form in which the R signal value 54, the G signal value 56, and the B signal value 58 representing the correct answer image 96 are saturated at the upper limit brightness of the high brightness region H without being saturated in the low brightness region L and the medium brightness region M. However, this is merely an example. The highest signal value among the R signal value 54, the G signal value 56, and the B signal value 58 representing the correct answer image 96 may be saturated on a low brightness side with respect to the medium signal value and the lowest signal value. For example, as illustrated in FIG. 9, the B signal value 58 among the R signal value 54, the G signal value 56, and the B signal value 58 representing the image region 95 may be saturated on a low brightness side with respect to the G signal value 56 and the R signal value 54. In the example illustrated in FIG. 9, the B signal value 58 representing the image region 95 is saturated at the boundary position between the low brightness region L and the medium brightness region M, and its saturation state is maintained from the boundary position between the low brightness region L and the medium brightness region M to the upper limit brightness of the high brightness region H. Even in a case where the trained model 52 is generated by performing the machine learning on the model 98 using the training data 92 including the correct answer image 96 configured as described above, the trained model 52 can be caused to generate and output an image in which the color saturation region 16A is suppressed compared to that in the captured image 14 as the AI image 112.

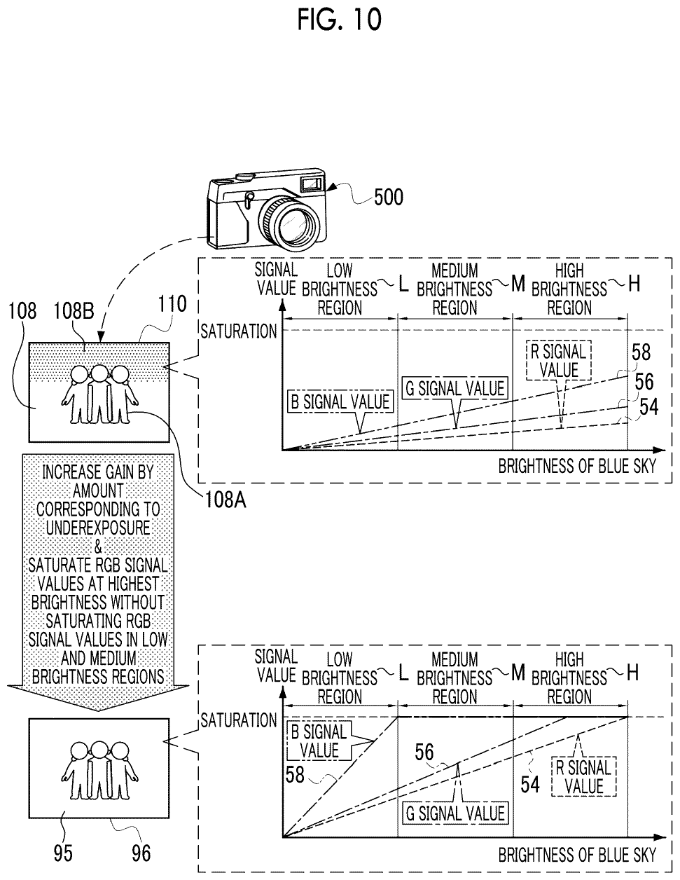

For example, as illustrated in FIG. 10, the B signal value 58 among the R signal value 54, the G signal value 56, and the B signal value 58 representing the image region 95 may be saturated on a low brightness side with respect to the G signal value 56 and the R signal value 54, and the G signal value 56 may be saturated on a low brightness side with respect to the R signal value 54. In the example illustrated in FIG. 10, the B signal value 58 representing the image region 95 is saturated at the boundary position between the low brightness region L and the medium brightness region M, and its saturation state is maintained from the boundary position between the low brightness region L and the medium brightness region M to the upper limit brightness of the high brightness region H. The G signal value 56 representing the image region 95 is saturated in the middle of the high brightness region H, and its saturation state is maintained from the middle of the high brightness region H to the upper limit brightness of the high brightness region H. Even in a case where the trained model 52 is generated by performing the machine learning on the model 98 using the training data 92 including the correct answer image 96 configured as described above, the trained model 52 can be caused to generate and output an image in which the color saturation region 16A is suppressed compared to that in the captured image 14 as the AI image 112.

In the embodiment, an example of a form in which the high image quality image 114 is generated by calculating the arithmetic mean of the captured image 14 and the AI image 112 or by blending the captured image 14 and the AI image 112 at the predetermined blending ratio is illustrated. However, the present disclosure is not limited to this. For example, the high image quality image 114 may be generated by blending the captured image 14 and the AI image 112 in accordance with a blending ratio determined in units of the standard regions based on the color signal values representing the captured image 14 and on a classification result obtained by performing object classification processing on the captured image 14 or the AI image 112 in units of the standard regions (for example, in units of pixels) using an AI.

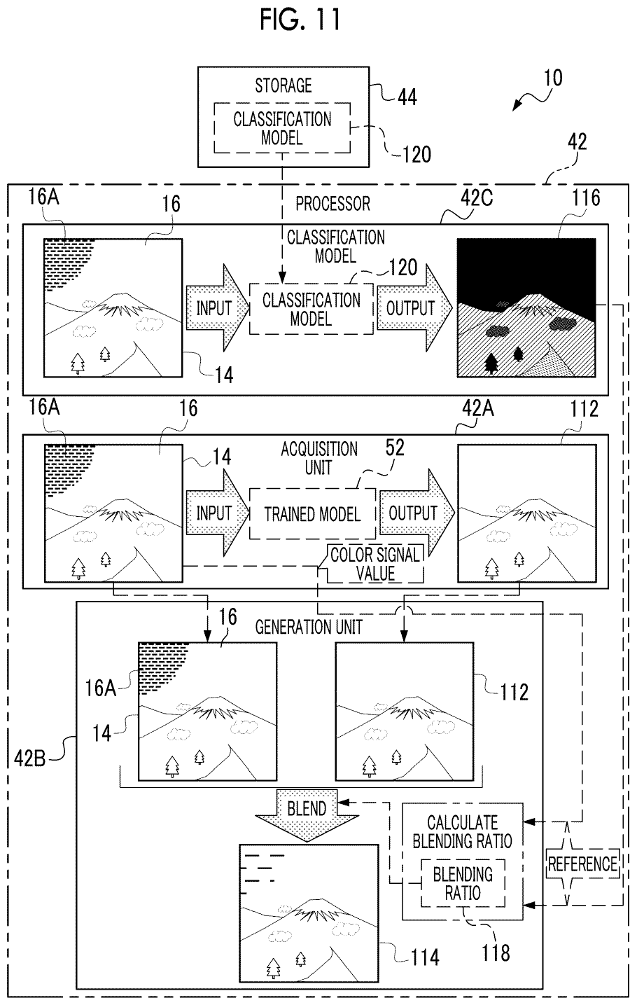

In this case, for example, as illustrated in FIG. 11, the generation unit 42B generates the high image quality image 114 by calculating a blending ratio 118 determined in units of pixels with reference to the color signal values representing the captured image 14 and to a segmentation image 116 and blending the captured image 14 and the AI image 112 in accordance with the calculated blending ratio 118.

In order to implement this, a classification model 120 is stored in the storage 44 in the imaging apparatus 10. The classification model 120 is a trained model obtained by optimizing a model by performing machine learning on a model (for example, a SegNet, a U-Net, or an HRNet) having an encoder and decoder structure using a plurality of pieces of training data including an example image in which one or more objects are captured and a correct answer image to which a label indicating a type of the one or more objects captured in the example image is assigned. The captured image 14 is input into the classification model 120. The classification model 120 is a model that classifies a plurality of objects captured in the input captured image 14 in units of pixels. For example, the classification model 120 classifies the plurality of objects captured in the input captured image 14 using a segmentation method (for example, a method using semantic segmentation, a method using instance segmentation, or a method using panoptic segmentation). In the example illustrated in FIG. 11, the classification model 120 is an example of an “AI” according to the present disclosure.

The processor 42 is different from the processor 42 described in the embodiment in that the processor 42 further operates as a classification unit 42C. The classification unit 42C performs object classification processing on the captured image 14 in units of pixels using an AI (that is, processing of classifying the plurality of objects captured in the captured image 14 in units of pixels). That is, the classification unit 42C causes the classification model 120 stored in the storage 44 to classify the plurality of objects captured in the captured image 14 in units of pixels by inputting the captured image 14 into the classification model 120 and outputs the segmentation image 116 indicating a classification result.

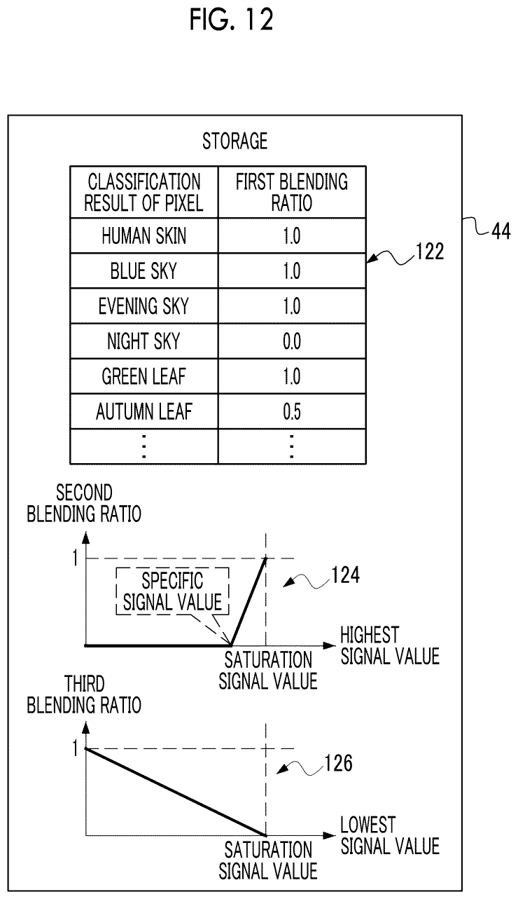

For example, as illustrated in FIG. 12, the generation unit 42B uses a first blending ratio table 122, a second blending ratio table 124, and a third blending ratio table 126 in order to calculate the blending ratio 118 with reference to the color signal values representing the captured image 14 and to the segmentation image 116.

As illustrated in FIG. 12, the first blending ratio table 122, the second blending ratio table 124, and the third blending ratio table 126 are stored in the storage 44. The first blending ratio table 122 is a table in which the classification result of the segmentation image 116 in units of pixels (that is, a result obtained by classifying each object captured in the captured image 14 in units of pixels) and a first blending ratio are associated with each other. The first blending ratio is a ratio at which the AI image 112 is used in a case where the captured image 14 and the AI image 112 are blended by the generation unit 42B. The first blending ratio is determined for each classification result (that is, the object captured in the captured image 14) in a range of greater than or equal to 0 and less than or equal to 1.

The second blending ratio table 124 is a table in which the highest signal value and a second blending ratio are associated with each other. Like the first blending ratio, the second blending ratio is a ratio at which the AI image 112 is used in a case where the captured image 14 and the AI image 112 are blended by the generation unit 42B. The second blending ratio is determined in a range of greater than or equal to 0 and less than or equal to 1. The second blending ratio is “0” from the highest signal value of “0” to a specific signal value and is monotonically increased from the specific signal value to a saturation signal value (that is, a saturated signal value). For example, the specific signal value refers to a signal value derived in advance by performing an experiment using an actual apparatus and/or a computer simulation or the like as a lower limit value of the highest signal value with which the color saturation region 16A is highly likely to occur. Setting the second blending ratio to a value greater than “0” from the specific signal value to the saturation signal value makes the color saturation region 16A easily affected by the AI image 112 compared to an image region other than the color saturation region 16A. Accordingly, the AI image 112 is more dominantly blended in an image region in which the color signal values are easily saturated than the captured image 14. Thus, an image in which the color saturation region 16A is suppressed is easily obtained as the high image quality image 114.

The third blending ratio table 126 is a table in which the lowest signal value and a third blending ratio are associated with each other. Like the first blending ratio and the second blending ratio, the third blending ratio is a ratio at which the AI image 112 is used in a case where the captured image 14 and the AI image 112 are blended by the generation unit 42B. In a case where the color saturation region 16A is colored, the image is likely to be unnatural as a whole. Therefore, the third blending ratio is monotonically decreased from the lowest signal value of “0” to the saturation signal value so that a washed-out part in the captured image 14 blended with the AI image 112 is not easily affected by the AI image 112.

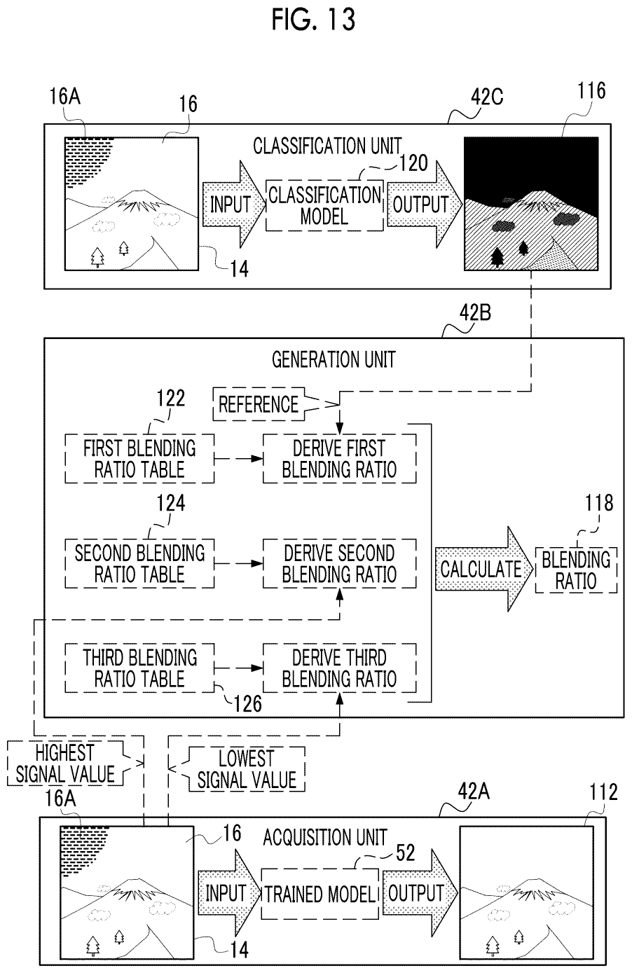

For example, as illustrated in FIG. 13, the generation unit 42B calculates the blending ratio 118 based on the first blending ratio table 122, the second blending ratio table 124, and the third blending ratio table 126 stored in the storage 44. The blending ratio 118 is determined in units of pixels and is determined based on the first blending ratio, the second blending ratio, and the third blending ratio.

The generation unit 42B derives the first blending ratio corresponding to the classification result of the classification model 120 from the first blending ratio table 122 for each pixel in the segmentation image 116. The generation unit 42B derives the second blending ratio corresponding to the highest signal value (in the example illustrated in FIG. 2, the B signal value 58) of the captured image 14 acquired from the image sensor 32 by the acquisition unit 42A from the second blending ratio table 124 in units of pixels. The generation unit 42B derives the third blending ratio corresponding to the lowest signal value (in the example illustrated in FIG. 2, the R signal value 54) of the captured image 14 acquired from the image sensor 32 by the acquisition unit 42A from the third blending ratio table 126 in units of pixels.

The generation unit 42B calculates the blending ratio 118 by multiplying the first blending ratio, the second blending ratio, and the third blending ratio in units of pixels. The generation unit 42B generates the high image quality image 114 by blending the captured image 14 and the AI image 112 in units of pixels in accordance with the blending ratio 118 (refer to FIG. 11). In the example illustrated in FIG. 13, the blending ratio 118 is an example of a “blending ratio” according to the present disclosure.

As described above, by calculating the blending ratio 118 by multiplying the first blending ratio, the second blending ratio, and the third blending ratio in units of pixels and blending the captured image 14 and the AI image 112 in units of pixels in accordance with the calculated blending ratio 118, occurrence of an event in which the high image quality image 114 is affected too much by the captured image 14 or the AI image 112, or the high image quality image 114 is affected too little by the captured image 14 or the AI image 112 can be suppressed. Consequently, an effect of the AI image 112 can be appropriately reflected on the color saturation region 16A, and too much coloring of the color saturation region 16A can be suppressed.

In the examples illustrated in FIGS. 11 and 13, an example of a form of inputting the captured image 14 into the classification model 120 and outputting the segmentation image 116 for the captured image 14 from the classification model 120 is illustrated. However, this is merely an example. The AI image 112 may be input into the classification model 120, and the segmentation image 116 for the AI image 112 may be output from the classification model 120. Even in this case, the same effect can be expected.

In the examples illustrated in FIGS. 11 and 13, an example of a form in which the classification unit 42C classifies the plurality of objects captured in the captured image 14 using the segmentation method has been illustratively described. However, this is merely an example. The classification unit 42C may classify the plurality of objects captured in the captured image 14 using a bounding box method. In this case, the blending ratio 118 is calculated in units of bounding boxes, and the high image quality image 114 is generated by blending the captured image 14 and the AI image 112 in units of blending boxes in accordance with the blending ratio 118.

As described above, the generation unit 42B may calculate the blending ratio 118 in units of the standard regions (for example, in units of pixels or in units of sets of a plurality of pixels such as bounding boxes) and generate the high image quality image 114 by blending the captured image 14 and the AI image 112 in units of the standard regions in accordance with the calculated blending ratio 118.

In the examples illustrated in FIGS. 11 to 13, an example of a form in which the blending ratio 118 is determined based on the first blending ratio, the second blending ratio, and the third blending ratio is illustrated. However, this is merely an example. The blending ratio 118 may be determined based on one or two of the first blending ratio, the second blending ratio, and the third blending ratio. The one or two of the first blending ratio, the second blending ratio, and the third blending ratio used for generating the blending ratio 118 may be determined in accordance with an instruction received by the UI system device 34 or a reception device connected to the external I/F 36. The high image quality image 114 generated in accordance with the blending ratio 118 determined as described above may be displayed on the UI system device 34 or a display device connected to the external I/F 36. A plurality of high image quality images 114 generated in accordance with a plurality of blending ratios 118, respectively, may be displayed on the UI system device 34 or the display device connected to the external I/F 36 in a comparable state. The high image quality image 114 to be finally employed from the plurality of high image quality images 114 may be determined in accordance with an instruction received by the UI system device 34 or the reception device connected to the external I/F 36 in a state where the plurality of high image quality images 114 are displayed on the UI system device 34 or the display device connected to the external I/F 36 in a comparable state.

While an example of a form in which the first blending ratio is derived from the first blending ratio table 122 is illustrated in the example illustrated in FIG. 13, this is merely an example. For example, the first blending ratio may be output by the classification model 120 in units of pixels. In this case, for example, the first blending ratio may be included in a label (in other words, an annotation assigned for each pixel) included in the training data used for the machine learning for generating the classification model 120 together with information indicating the type of the object.

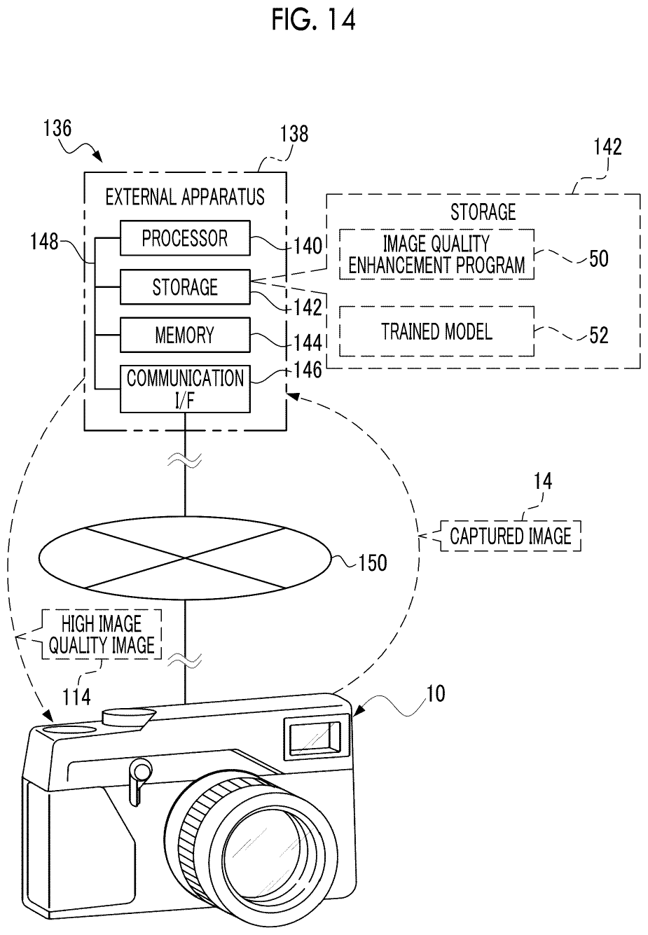

While an example of a form in which the processor 42 of the computer 30 included in the imaging apparatus 10 performs the image quality enhancement processing has been illustratively described in the embodiment, the present disclosure is not limited to this. A device that performs the image quality enhancement processing may be provided outside the imaging apparatus 10. In this case, for example, as illustrated in FIG. 14, an imaging system 136 may be used. The imaging system 136 comprises the imaging apparatus 10 and an external apparatus 138. For example, the external apparatus 138 is a server. For example, the server is implemented by cloud computing. While cloud computing is illustrated, this is merely an example. For example, the server may be implemented by a mainframe or may be implemented by network computing such as fog computing, edge computing, or grid computing. While a server is illustrated as an example of the external apparatus 138, this is merely an example. At least one personal computer or the like may be used as the external apparatus 138 instead of the server.

The external apparatus 138 comprises a processor 140, a storage 142, a memory 144, and a communication I/F 146. The processor 140, the storage 142, the memory 144, and the communication I/F 146 are connected by a bus 148. The communication I/F 146 is connected to the imaging apparatus 10 through a network 150. For example, the network 150 is the internet. The network 150 is not limited to the internet and may be a WAN and/or a LAN such as an intranet.

The image quality enhancement program 50 and the trained model 52 are stored in the storage 142. The processor 140 executes the image quality enhancement program 50 in the memory 144. The processor 140 performs the image quality enhancement processing in accordance with the image quality enhancement program 50 executed on the memory 144. In performing the image quality enhancement processing, the processor 140 processes the captured image 14 using the trained model 52 in the same manner as described in the embodiment. The captured image 14 is transmitted to the external apparatus 138 from the imaging apparatus 10 through the network 150. The communication I/F 146 of the external apparatus 138 receives the captured image 14. The processor 140 processes the captured image 14 received by the communication I/F 146 using the trained model 52 described in the embodiment and performs processing of generating the high image quality image 114 by blending the captured image 14 and the AI image 112. The processor 140 transmits the generated high image quality image 114 to the imaging apparatus 10 through the communication I/F 146. The imaging apparatus 10 receives the high image quality image 114 transmitted from the external apparatus 138 via the external I/F 36 (refer to FIG. 2).

FIG. 14 illustrates an example of a form in which the imaging apparatus 10 causes the external apparatus 138 to execute the image quality enhancement processing. However, this is merely an example. For example, the imaging apparatus 10 and the external apparatus 138 may execute the image quality enhancement processing in a distributed manner, or the imaging apparatus 10 and a plurality of apparatuses including the external apparatus 138 may execute the image quality enhancement processing in a distributed manner.

While an example of a form in which the image quality enhancement program 50 is stored in the storage 44 has been illustratively described in the embodiment, the present disclosure is not limited to this. For example, the image quality enhancement program 50 may be stored in a portable computer-readable non-transitory storage medium such as an SSD or a USB memory. The image quality enhancement program 50 stored in the non-transitory storage medium is installed on the computer 30 of the imaging apparatus 10. The processor 42 executes the image quality enhancement processing in accordance with the image quality enhancement program 50.

The image quality enhancement program 50 may be stored in a storage device of another computer, a server apparatus, or the like connected to the imaging apparatus 10 through a network, and the image quality enhancement program 50 may be downloaded in response to a request of the imaging apparatus 10 and installed on the computer 30.

The storage device of another computer, a server apparatus, or the like connected to the imaging apparatus 10 or the storage 44 does not necessarily store the entire image quality enhancement program 50 and may store a part of the image quality enhancement program 50. While the image quality enhancement program 50 is mentioned, the same applies to the learning program 90.

While the computer 30 is incorporated in the imaging apparatus 10 illustrated in FIG. 2, the present disclosure is not limited to this. For example, the computer 30 may be provided outside the imaging apparatus 10.

While the computer 30 is illustrated in the embodiment, the present disclosure is not limited to this. A device including an ASIC, an FPGA, and/or a PLD may be applied instead of the computer 30. A combination of a hardware configuration and a software configuration may also be used instead of the computer 30.

Various processors illustrated below can be used as a hardware resource for executing the image quality enhancement processing and/or the learning processing described in the embodiment. Examples of the processor include a CPU that is a general-purpose processor functioning as the hardware resource for executing the image quality enhancement processing and/or the learning processing by executing software, that is, a program. Examples of the processor also include a dedicated electric circuit such as an FPGA, a PLD, or an ASIC that is a processor having a circuit configuration dedicatedly designed to execute specific processing. A memory is incorporated in or connected to any of the processors, and any of the processors executes the image quality enhancement processing and/or the learning processing using the memory.

The hardware resource for executing the image quality enhancement processing and/or the learning processing may be composed of one of the various processors or be composed of a combination of two or more processors of the same type or different types (for example, a combination of a plurality of FPGAs or a combination of a CPU and an FPGA). The hardware resource for executing the image quality enhancement processing and/or the learning processing may also be one processor.

Examples of the hardware resource composed of one processor include, first, a form of one processor composed of a combination of one or more CPUs and software, in which the processor functions as the hardware resource for executing the image quality enhancement processing and/or the learning processing. Second, as represented by an SoC or the like, a form of using a processor that implements functions of the entire system including a plurality of hardware resources for executing the image quality enhancement processing and/or the learning processing in one IC chip is included. As described above, the image quality enhancement processing and/or the learning processing are implemented using one or more of the various processors as the hardware resource.

More specifically, an electric circuit in which circuit elements such as semiconductor elements are combined can be used as a hardware structure of the various processors. The image quality enhancement processing and/or the learning processing is merely an example. Accordingly, it is possible to delete an unnecessary step, add a new step, or change a processing order without departing from the gist of the present disclosure.

Above described content and illustrated content are detailed description for parts according to the present disclosure and are merely an example of the present disclosure. For example, description related to the above configurations, functions, actions, and effects is description related to examples of configurations, functions, actions, and effects of the parts according to the present disclosure. Thus, it is possible to remove an unnecessary part, add a new element, or replace a part in the above described content and the illustrated content without departing from the gist of the present disclosure. Particularly, description related to common technical knowledge or the like that is not required to be described for embodying the present disclosure is omitted in the above described content and the illustrated content in order to avoid complication and facilitate understanding of the parts according to the present disclosure.

All documents, patent applications, and technical standards disclosed in the present specification are incorporated in the present specification by reference to the same extent as those in a case where each of the documents, patent applications, and technical standards are specifically and individually indicated to be incorporated by reference.

The following appendixes are further disclosed with respect to the above embodiment.

### Appendix 1

Training data used for machine learning of a model, the training data comprising an example image determined by assuming a captured image obtained by imaging a subject, and a correct answer image, in which the example image is an image represented by a plurality of first signal values indicating three primary colors of light, the correct answer image is an image represented by a plurality of second signal values indicating the three primary colors, the plurality of first signal values are saturated in order in accordance with an increase in brightness of the subject, and at least two of the plurality of second signal values are increased in accordance with an increase in the brightness of the subject without being saturated in a low brightness region and a medium brightness region among the low brightness region of the subject, the medium brightness region of the subject, and a high brightness region of the subject.

### Appendix 2

A trained model obtained by optimizing the model by performing the machine learning on the model using the training data according to Appendix 1.

### Appendix 3

A computer-readable non-transitory storage medium storing a program causing a computer to execute a process comprising acquiring the captured image and a first image output from the trained model according to Appendix 2 by inputting an image for inference into the trained model, and generating a second image by blending the first image and the captured image.

### Appendix 4

A computer-readable non-transitory storage medium storing a program causing a computer to execute a process comprising inputting an image for inference into the trained model according to Appendix 2, and acquiring an inference result output from the trained model in accordance with input of the image for inference.

What is claimed is:

1. Training data used for machine learning of a model, the training data comprising:
an example image determined by assuming a captured image obtained by imaging a subject; and
a correct answer image,
wherein the example image is an image represented by a plurality of first signal values indicating three primary colors of light,
the correct answer image is an image represented by a plurality of second signal values indicating the three primary colors,
the plurality of first signal values are saturated in order in accordance with an increase in brightness of the subject, and
at least two of the plurality of second signal values are increased in accordance with an increase in the brightness of the subject without being saturated in a low brightness region and a medium brightness region among the low brightness region of the subject, the medium brightness region of the subject, and a high brightness region of the subject.

2. The training data according to claim 1,
wherein the plurality of first signal values are saturated in an order corresponding to a color of the subject in accordance with an increase in the brightness of the subject.

3. The training data according to claim 1,
wherein the example image and the correct answer image are images generated based on a standard image indicating the subject,
the standard image is an image represented by a plurality of third signal values indicating the three primary colors, and
the plurality of third signal values are increased at a constant ratio in accordance with an increase in the brightness of the subject.

4. The training data according to claim 3,
wherein a ratio at which the plurality of first signal values are increased in accordance with an increase in the brightness of the subject is higher than the ratio at which the plurality of third signal values are increased in accordance with an increase in the brightness of the subject.

5. The training data according to claim 3,
wherein the example image is an image obtained by increasing a gain of the standard image.

6. The training data according to claim 3,
wherein the correct answer image is an image obtained by increasing a gain of the standard image, maintaining a magnitude relationship among the plurality of third signal values in the low brightness region, the medium brightness region, and the high brightness region, and saturating at least two of the plurality of third signal values in the high brightness region without saturating the at least two of the plurality of third signal values in the low brightness region and the medium brightness region, and
an amount of increase in the gain varies depending on the brightness of the subject.

7. A trained model obtained by optimizing the model by performing the machine learning on the model using the training data according to claim 1.

8. An image processing device comprising:
a first processor,
wherein the first processor is configured to:
acquire the captured image and a first image output from the trained model according to claim 7 by inputting an image for inference into the trained model; and
generate a second image by blending the first image and the captured image.

9. The image processing device according to claim 8,
wherein the first processor is configured to generate the second image by blending the first image and the captured image in units of standard regions.

10. The image processing device according to claim 9,
wherein the first processor is configured to generate the second image by blending the first image and the captured image in accordance with a blending ratio determined in units of the standard regions,
the blending ratio is a value based on at least one of a first blending ratio, a second blending ratio, or a third blending ratio,
the first blending ratio is determined in accordance with a classification result obtained by performing object classification processing on the captured image or the first image in units of the standard regions using an AI,
the second blending ratio is determined in accordance with a highest signal value among a plurality of fourth signal values indicating the three primary colors in units of the standard regions for the second image, and
the third blending ratio is determined in accordance with a lowest signal value among the plurality of fourth signal values.

11. An imaging apparatus comprising:
a second processor; and
an image sensor,
wherein the second processor is configured to:
input an image for inference into the trained model according to claim 7; and
acquire an inference result output from the trained model in accordance with input of the image for inference, and
the captured image is obtained by imaging the subject via the image sensor.

12. A learning device comprising:
a third processor,
wherein the third processor is configured to optimize the model by performing the machine learning on the model using the training data according to claim 1.

13. A method of creating training data used for machine learning of a model,
the training data including an example image determined by assuming a captured image obtained by imaging a subject, and a correct answer image,
the method comprising:
creating the correct answer image; and
creating the example image,
wherein the example image is an image represented by a plurality of first signal values indicating three primary colors of light,
the correct answer image is an image represented by a plurality of second signal values indicating the three primary colors,
the plurality of first signal values are saturated in order in accordance with an increase in brightness of the subject, and
at least two of the plurality of second signal values are increased in accordance with an increase in the brightness of the subject without being saturated in a low brightness region and a medium brightness region among the low brightness region of the subject, the medium brightness region of the subject, and a high brightness region of the subject.

14. A method of generating a trained model by performing machine learning on a model using training data,
the training data including a correct answer image, and an example image determined by assuming a captured image obtained by imaging a subject,
the example image being an image represented by a plurality of first signal values indicating three primary colors of light,
the correct answer image being an image represented by a plurality of second signal values indicating the three primary colors,
the plurality of first signal values being saturated in order in accordance with an increase in brightness of the subject, and
at least two of the plurality of second signal values being increased in accordance with an increase in the brightness of the subject without being saturated in a low brightness region and a medium brightness region among the low brightness region of the subject, the medium brightness region of the subject, and a high brightness region of the subject,
the method comprising:
inputting the example image into the model;
outputting an evaluation target image in accordance with input of the example image via the model; and
optimizing the model based on a comparison result between the evaluation target image and the correct answer image.

15. An image processing method comprising:
acquiring the captured image and a first image output from the trained model according to claim 7 by inputting an image for inference into the trained model; and
generating a second image by blending the first image and the captured image.

16. An inference method comprising:
inputting an image for inference into the trained model according to claim 7; and
acquiring an inference result output from the trained model in accordance with input of the image for inference.

17. A non-transitory computer-readable storage medium storing a program executable by a computer to execute a process comprising:
acquiring the captured image and a first image output from the trained model according to claim 7 by inputting an image for inference into the trained model; and
generating a second image by blending the first image and the captured image.

18. A non-transitory computer-readable storage medium storing a program executable by a computer to execute a process comprising:
inputting an image for inference into the trained model according to claim 7; and
acquiring an inference result output from the trained model in accordance with input of the image for inference.
